(19) United States
(12) Patent Application Publication
(10) Pub. No.: US 2015/0100983 A1
(43) Pub. Date: Apr. 9, 2015

(54) Personal Mobile Device as Ad hoc Set-Top Box for Television

(71) Applicant: Yang Pan, Singapore (SG)

(72) Inventor: Yang Pan, Singapore (SG)

(21) Appl. No.: 14/046,972

(22) Filed: Oct. 6, 2013

(51) Int. Cl. H04N 21/41; H04N 21/436; H04N 21/4782; H04N 21/478; H04N 21/422; H04N 21/482

(52) U.S. Cl. CPC H04N 21/4126; H04N 21/42209; H04N 21/42221; H04N 21/4222; H04N 21/482; H04N 21/4782; H04N 21/478; H04N 21/43615
USPC 725/39

(57) ABSTRACT

In a basic form, a television renders programs received from channel content providers through cable or satellite. A personal mobile device is coupled to the television as an ad hoc set-top box. The personal mobile device takes control of television system and provides a network search capability. Personal media items stored in a storage unit of the device can also be rendered by the television. The personal mobile device renders a user interface through the television. A first screen of a user interface includes a channel selector, a network search engine and a personal media user interface.

### CROSS-REFERENCE TO RELATED APPLICATIONS

Not applicable.

### BACKGROUND

1. Field of Invention

This invention relates generally to media item delivery. More specifically, the invention relates to system and method for delivering a media item through the use of a digital television system and personal mobile computing and communication devices.

2. Description of Prior Art

Personal mobile devices have gained significant popularity in recent years. Users are using the mobile device such as, for example, iPhone, iPod and iPad from Apple Inc, Cupertino, Calif., to enjoy media assets and to access the Internet services. Methods for delivering video programs to users by employing personal mobile devices have been developed.

Because of significantly larger display size and comfortable environment in a living room, many of video programs have still been delivered to users through a television (TV) system. System requirement for delivering video program from a cable or a satellite TV operator is very different from the one for delivering video program from the Internet. Present TV systems attempting to integrate abovementioned different sources of video program are complex and very often confuse a user. Therefore, it is desirable to have TV system providing clarity and simplicity for receiving video programs from both channel content providers and network content providers.

### SUMMARY OF THE INVENTION

It is an object of the present invention to providing novel digital TV system architecture by connecting a personal mobile device as an ad hoc set-top box (STB) to a basic TV system for receiving both channel programs from the channel content provider and video programs from a network content provider.

It is another object of the present invention to providing a graphical user interface rendered by the personal mobile device on a display of the TV system for a user to select a video program from one of the following sources: a channel program provider, a network content provider and a storage unit of the personal mobile device.

It is another object of the present invention to providing a novel television system based upon a television, a smart watch and a smart phone.

An exemplary system comprises a basic TV system including a television and a remote control device. The basic TV system receives and renders a video program from a channel content provider. The channel content provider includes but is not limited to a satellite TV operator and a cable TV operator. A personal mobile device can be connected to the television as an ad hoc STB. The personal mobile device is a general purpose mobile computing and communication device in a standalone form. The personal device includes but is not limited to a smart phone, a tablet computer, a laptop computer and a smart wearable device such as, for example, a smart watch. In one implementation, the personal device is connected to the television through an ad hoc wireless communication link. In another implementation, the personal mobile device is connected to the television through a docking system. Different personal mobile devices from the same or different users can be connected in an ad hoc manner to the television.

A remote control device is employed to control operations of the TV system. In one implementation, the remote control device is a dedicated device. In another implementation, the remote control device is a general purpose mobile computing and communication device that is connectable to at least the personal mobile device in an ad hoc manner.

In one aspect, a smart watch is connected to the TV system and a smart phone is connected to the smart watch as a remote control device. The smart phone and smart watch is connected through an ad hoc wireless communication link.

A user selects a media item through a user interface rendered by a processor of the personal device. The user interface displays user selectable items on a display of the TV. The user selectable items include at least a channel selector and a network search engine. The user selectable items may also include a personal media user interface for selecting a media item stored in a storage unit of the personal device.

In another aspect, a selected channel program may be recorded into the storage unit of the personal device. The recorded program can be rendered to a user through the TV if the personal device is connected. The recorded program can also be rendered to the user through the personal device if the device is not connected to the TV.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of an exemplary media delivery system based on coupling a general purpose mobile computing and communication device to the television as an ad hoc STB;

FIG. 2 is a schematic diagram of an exemplary media delivery system based on coupling a smart phone to the television as an ad hoc STB;

FIG. 3 is a schematic diagram of an exemplary media delivery system based on coupling a tablet computer to the television as an ad hoc STB;

FIG. 4 is a schematic diagram of an exemplary media delivery system based on coupling a laptop computer to the television as an ad hoc STB;

FIG. 5 is a schematic diagram of an exemplary media delivery system based on coupling a wearable device to the television as an ad hoc STB;

FIG. 6 is a schematic diagram of an exemplary media delivery system based on coupling a smart watch to the television while employing a smart phone as remote control;

FIG. 7 is a schematic diagram of an exemplary media delivery system based on coupling a smart phone to the television as an ad hoc STB and employing a smart watch as the remote control device;

FIG. 8 is a schematic illustration of various mobile devices that can be selected as the remote control device;

FIG. 9 is a schematic diagram illustrating the basic TV system (A) and its user interface (B);

FIG. 10 is a schematic diagram illustrating exemplarily user interface of the TV system when channel selector is selected by the user;

FIG. 11 is a schematic diagram illustrating exemplarily user interface of the TV system when the network search engine is selected by the user;

FIG. 12 is a schematic diagram illustrating exemplarily user interface of the TV system when the personal media UI is selected by the user;

FIG. 13 is a flowchart illustrating exemplarily operation of the media delivery system;

FIG. 14 is a flowchart illustrating exemplarily search operation of the media delivery system;

FIG. 15 is a flowchart illustrating exemplarily operation for accessing personal media in the personal mobile device;

FIG. 16 is a flowchart illustrating exemplarily operation for recoding and rendering recorded program.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

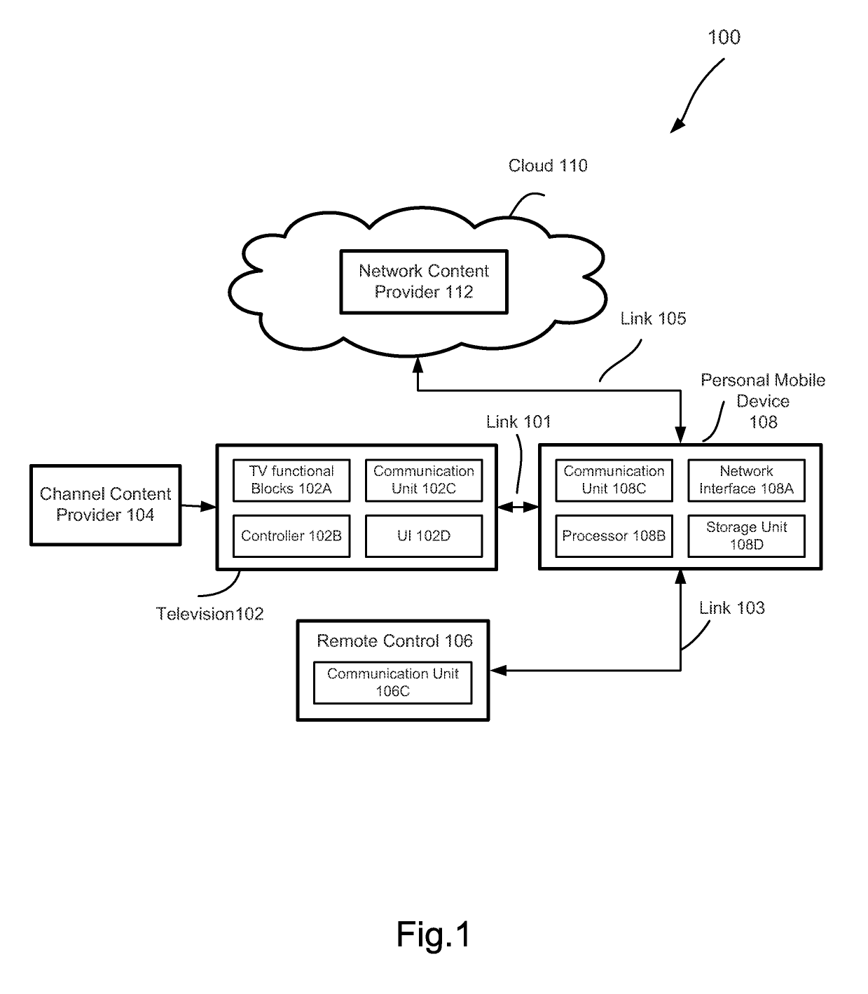

FIG. 1 is a schematic diagram illustrating an exemplary media delivery system 100. System 100 includes basic TV system comprising TV 102 and remote control device 106. The basic TV system receives channel TV programs from channel content provide 104 and renders received program using TV 102. Channel content provider 104 includes but is not limited a cable TV operator and a satellite TV operator. TV 102 includes conventional functional blocks 102A comprising such units as receiver, demodulator, video signal processing, audio signal processing, remote control receiver, speaker and display. Operation of TV 102 is controlled by controller 102B. A user controls the operation through remote control device 106.

In one aspect, a general purpose personal mobile device 108 is connected to TV 102 through a communication link 101. The personal device is used as an ad hoc set-top box (STB). The ad hoc STB is pertaining to receiving media items from cloud 110 and to rendering received media items through TV 102. Link 101 includes communication unit 102C in TV 102 and communication unit 108C in personal device 108. Personal device 108 includes but is not limited to a smart phone, a tablet computer, a laptop computer, a smart wearable device such as a smart watch. Personal device 108 can always be used as a standalone mobile device including many functions such as phone, Internet browser, email, message, and location determination. A conventional STB is a specialized appliance for TV. Personal device 108 used as the ad hoc STB includes but is not limited to the following characteristics:
1. The ad hoc STB is a general purpose mobile computing and communication device and can be used as a standalone device with many functions;
2. The device can be coupled and decoupled from the TV easily. If the device is connected to the TV through the ad hoc communication link, a disconnection is automatic when the user moves the device away from a range effective for the wireless communication protocol;
3. Different personal mobile devices from the same user can be used as the ad hoc STB;
4. Personal mobile devices from different uses can be used as the ad hoc STB;
5. Determining the identity of the user is intrinsic to the system; and
6. When no personal mobile device is connected, the TV system is operated independently in its basic form for rendering channel programs delivered from the channel content providers.

In one implementation, link 101 is an ad hoc wireless communication link. The ad hoc communication link 101 may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC). An authenticity check maybe conducted before the connection is confirmed. The personal mobile device 108 always carries the user's identity. Therefore, system 100 controlled by processor in the personal device knows the user's identity automatically. Targeted media items and advertising messages can be delivered.

In another implementation, link 101 is a wired connection. Personal device 108 is connected to TV 102 through a docking system. Communication units 102C and 108C may be conformed to IEEE 1394 protocol for a FIREWIRE type of connection. Communication units 102C and 108C may be a Universal Serial Bus (USB) type of connection.

Personal device 108 further includes processor 108B pertaining to controlling operations of the device. TV 102 includes UI 102D for rendering the media items to the user through the user's progressive interactions using remote control device 106. Processor 108B controls a process of rendering UI 102D on TV 102. A control signal generated from the user's interaction with the remote control device can be transmitted to processor 108B through communication link 103. The control signal can be further transmitted to TV 102 through communication link 101 controlled by processor 108B.

Remote control device 106 includes a communication unit 106C. In one implementation, link 103 built on communication unit 106C and 108C includes an ad hoc wireless communication link. The ad hoc communication link 103 may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC). In another implementation, link 103 is an optical communication link including infrared communication link.

In an alternative approach (not shown in the figure), communication unit 106C of remote control device 106 transmits the control signal to processor 108B through communication unit 102C and communication unit 108C.

Personal device 108 is connected to network or cloud 110 through communication link 105. Cloud 110 is the Internet in an exemplary case. Network interface 108A connects personal device 108 to cloud 110. Cloud 110 includes a network content provider 112. Network content provider 112 distributes media items to TV 102 through communication link 105.

Personal media items are stored in storage unit 108D. Personal media items in a general purpose mobile device are typically organized in a hierarchical manner and are delivered to the user through a hierarchical user interface. The user selects a personal media item through UI 102D. Selected media item is retrieved by processor 108B and is rendered using TV 102.

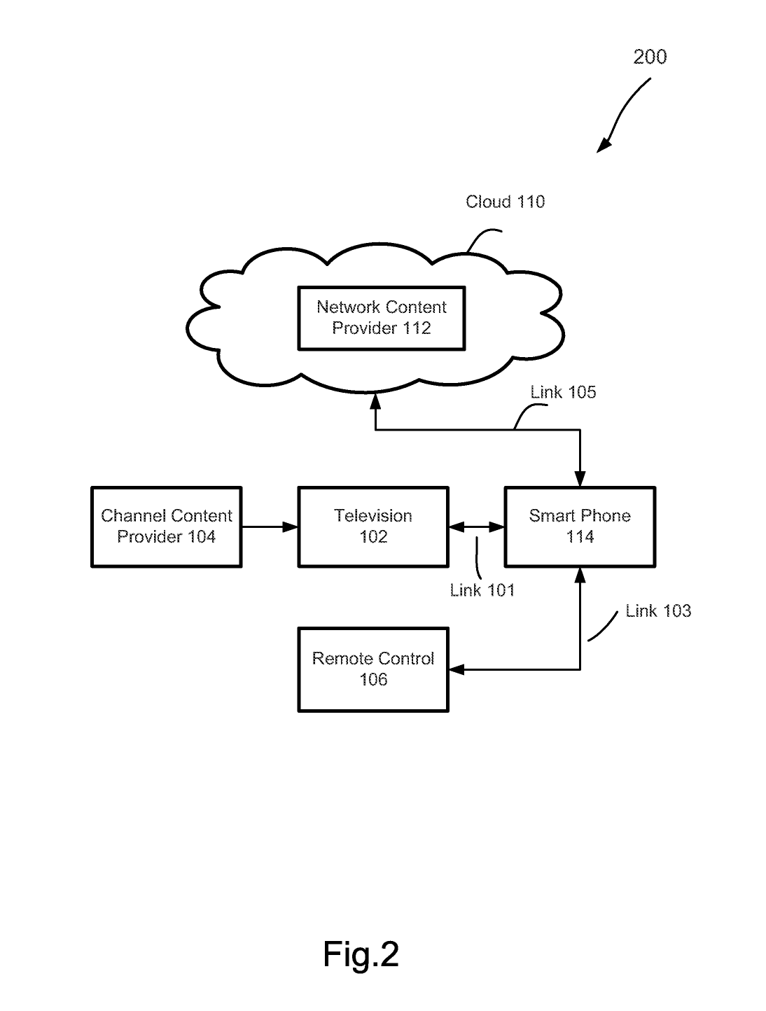

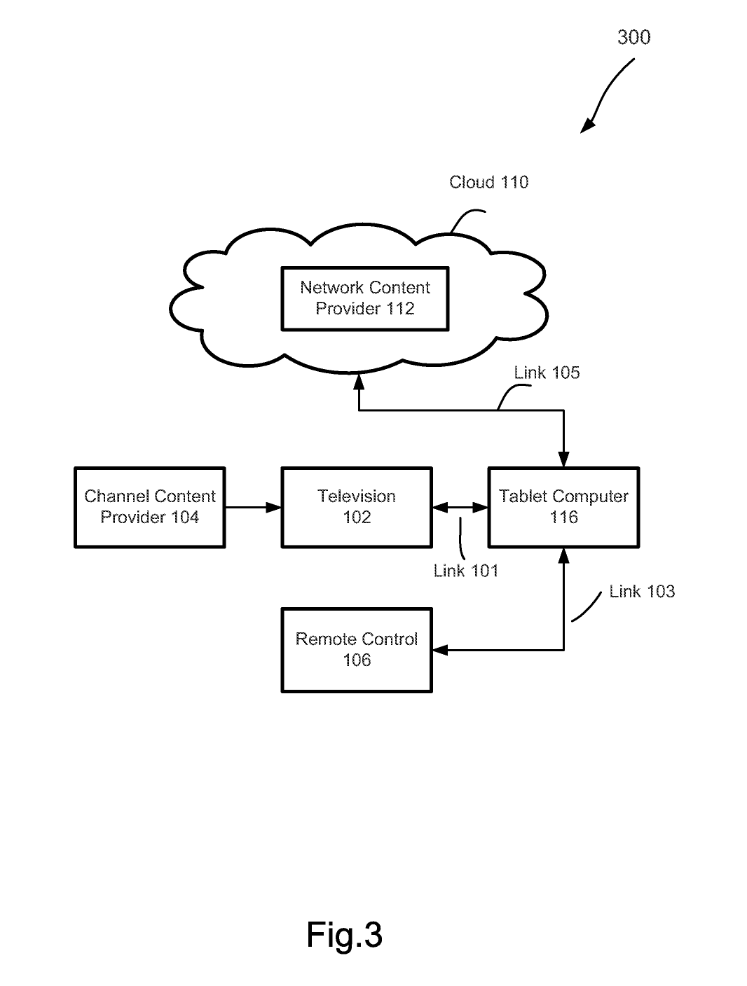

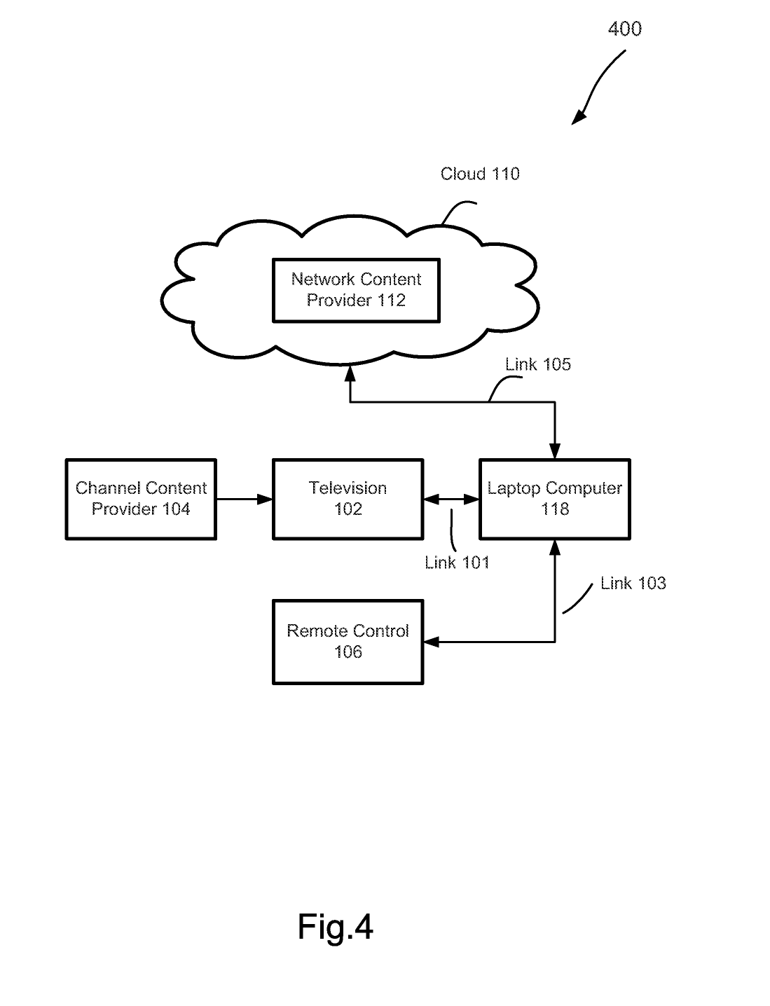

Exemplary media delivery 100 can take different types of personal mobile devices as the ad hoc STB including but are not limited to smart phone 114 in exemplary system 200 as shown in FIG. 2, tablet computer 116 in exemplary system 300 as shown in FIG. 3 and laptop computer 118 in exemplary system 400 as shown in FIG. 4.

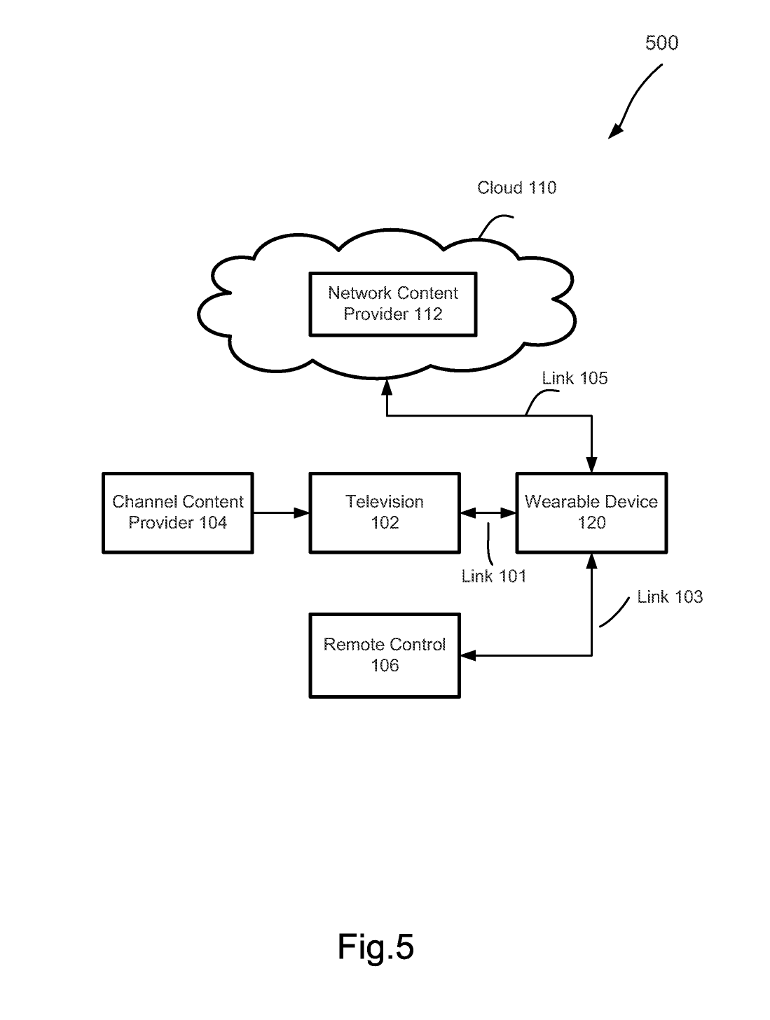

Smart wearable devices can also be used as the ad hoc STB. In one implementation, wearable device includes a network interface 108A for connecting the device to cloud 110. FIG. 5 is a schematic diagram of an exemplary media delivery system 500 based on coupling wearable device 120 to TV 102. Wearable device 120 includes but not limited to a smart watch, a smart glass and a smart garment.

In another implementation, wearable device does not include a network interface. In an exemplary case, smart watch 122 accesses to cloud 110 through smart phone 114. Smart watch 122 and smart phone 114 are connected through an ad hoc communication link including but not limited to a Bluetooth type of connection.

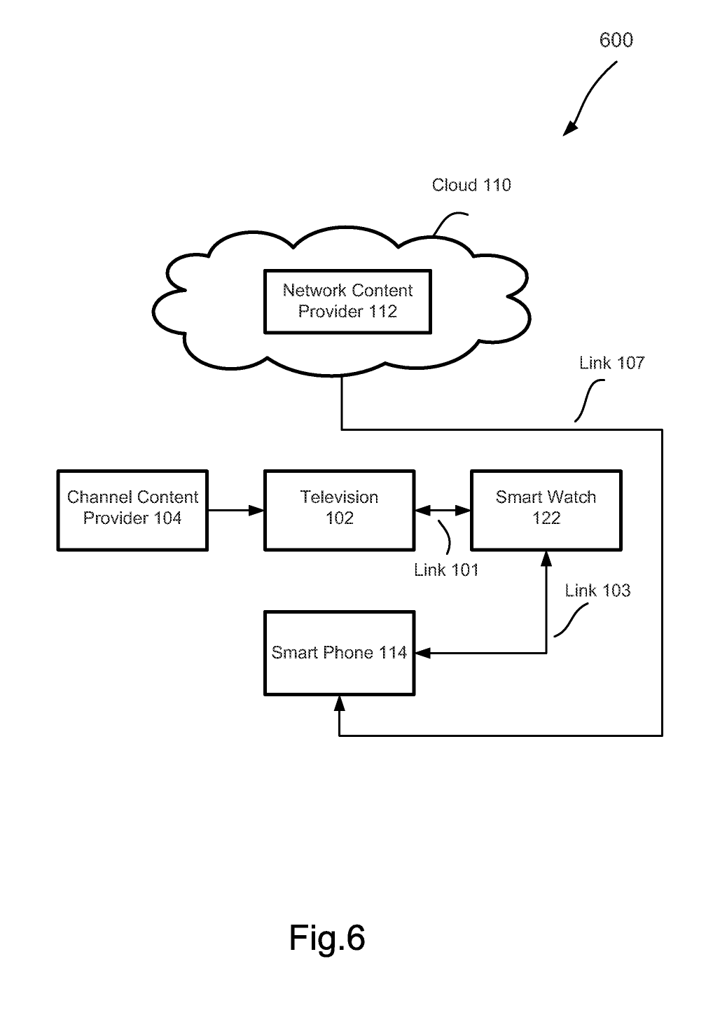

In an exemplary media delivery system 600 as shown in FIG. 6, smart watch 122 is connected to TV 102 through communication link 101. Smart watch 122 is a client device of smart phone 114 that is used as a remote control device. Smart watch 122 and smart phone 114 are connected through an ad hoc communication link 103. Smart watch 122 is connected to cloud 110 through smart phone 114. Smart phone 114 is connected to cloud 110 through a communication link 107. Communication link 107 comprises a wireless broadband communication link enabled by a network interface in smart phone 114.

In system 600, smart phone 114 and smart watch 122 are combined to deliver functions as an ad hoc STB and as a remote control device. Smart watch 122 cannot be used independently as the ad hoc STB because of lacking of the network interface for connecting to cloud 110 directly.

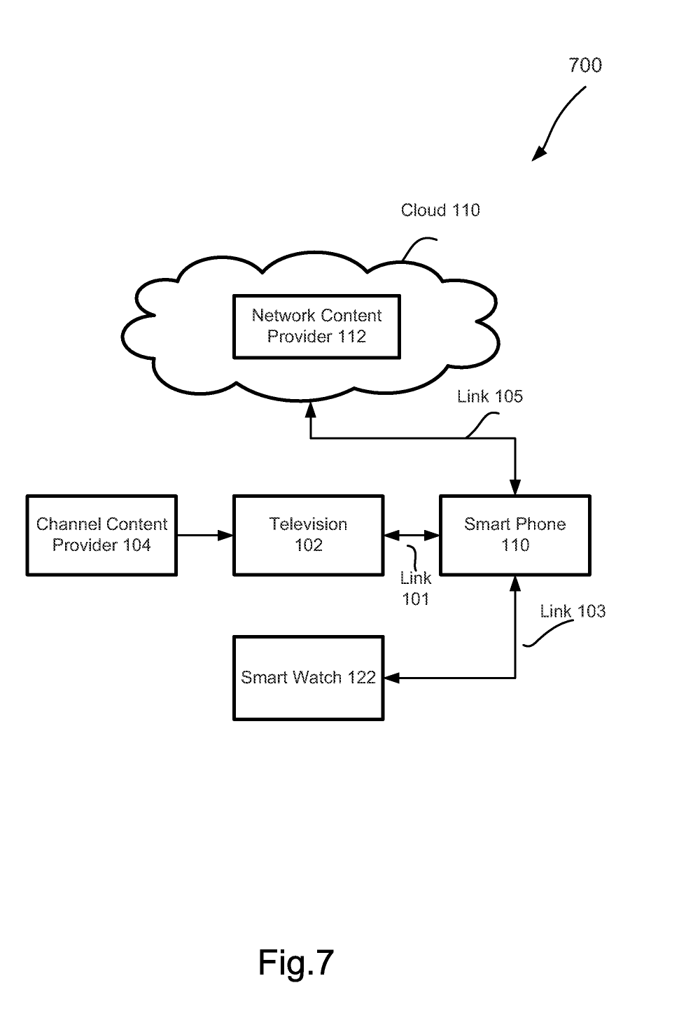

FIG. 7 is a schematic diagram of an exemplary media delivery system 700. Smart phone 114 is connected to TV 102. Smart watch 122 is used as the remote control device. In one implementation, smart watch 122 includes a touch-sensitive display. A blanket display screen can be used for the remote control. Smart phone 114 synchronizes a movement of an optical symbol on the display of TV 102 and a movement of a finger on the blanket display screen of smart watch 122. An action of touching down the screen of smart watch 122 by a finger will actuate a selection of displayed item on TV 102. In one implementation, backlight illumination for a typical liquid crystal display (LCD) can be switched off while the smart watch 122 is used as the remote control device. Touch sensors are maintained at switching-on status while backlight illumination is switched off.

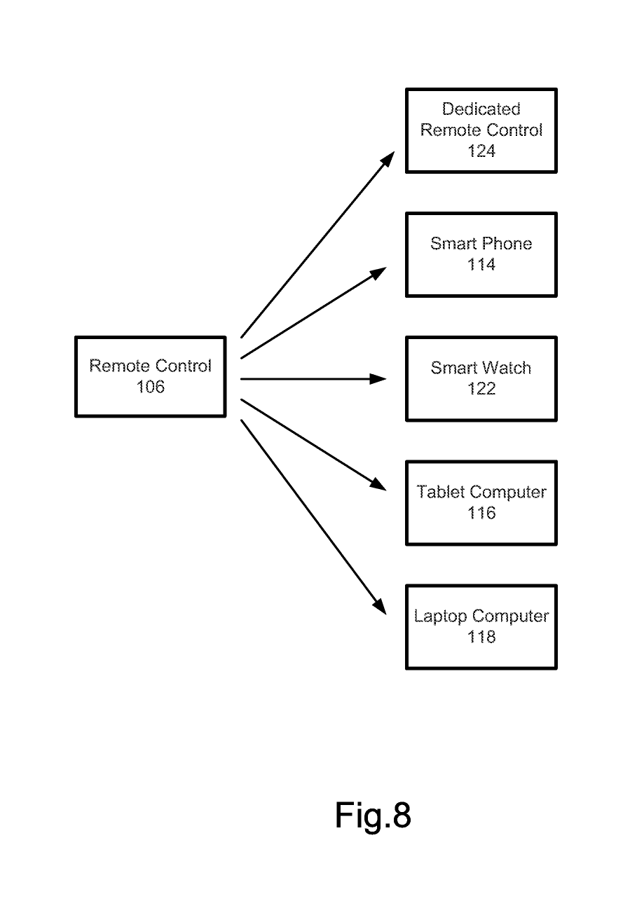

Many mobile devices can be used as remote control devices. Some examples are illustrated in FIG. 8. Remote control device 106 may be a dedicated remote control device 124. Remote control device 106 may also be based upon a general purpose mobile computing and communication devices including but not limited to smart phone 114, smart watch 122, tablet computer 116 and laptop computer 118. Remote control is implemented as one of the functions of the general purpose devices. Embodiments as illustrated from FIGS. 2-8 are exemplary. Many more different combinations for selecting an ad hoc STB device and for selecting a remote control device are possible. FIG. 1 is a generic description of the present inventive concept. All variations caused by different combinations of the ad hoc STB device and the remote control device fall into scope of the present inventive concept as obvious to one with ordinary skill in the art.

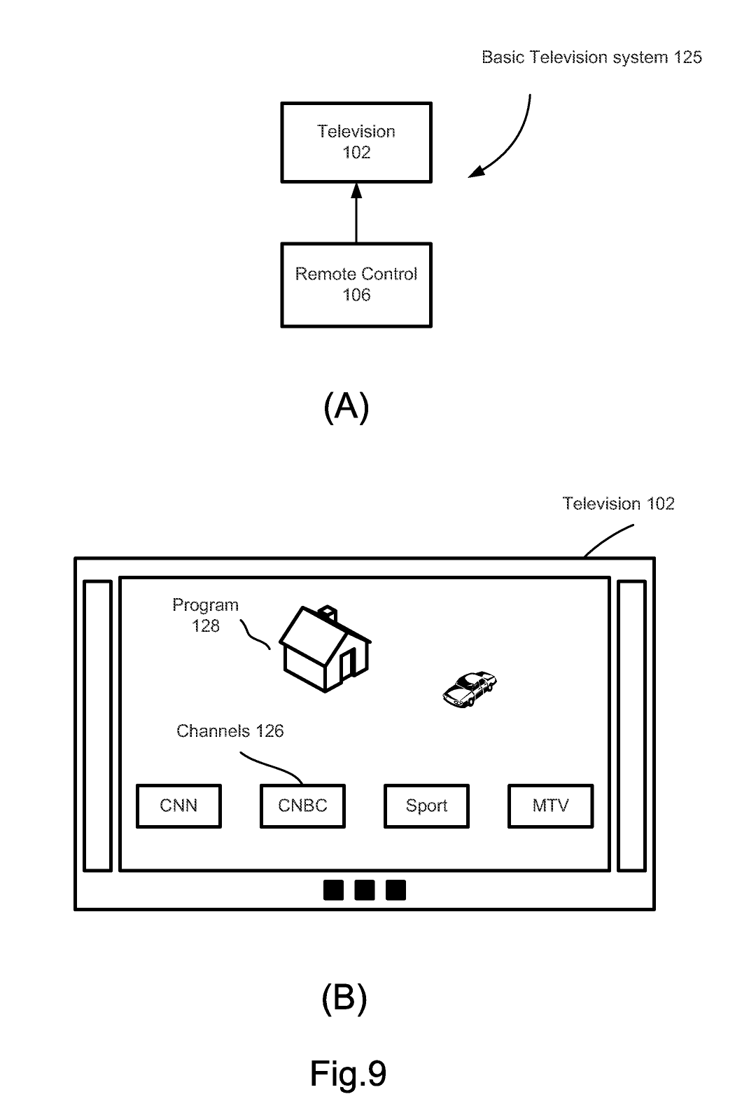

Exemplary media delivery system 100 as shown in FIG. 1 includes a basic TV system for receiving and rendering channel programs provided by channel content provider 104. Personal mobile device 108 used as the ad hoc STB connects network content provider 112 to the basic TV system. Network search functions are, therefore, added to the basic TV system. An exemplary basic TV system 125 is shown in FIG. 9A. An exemplary user interface for basic TV system 125 is illustrated in FIG. 9B. User selectable channels 126 are displayed on the display of TV 102. A channel maybe selected while a program 128 is being broadcasted. A channel may also be selected while no program is being broadcasted.

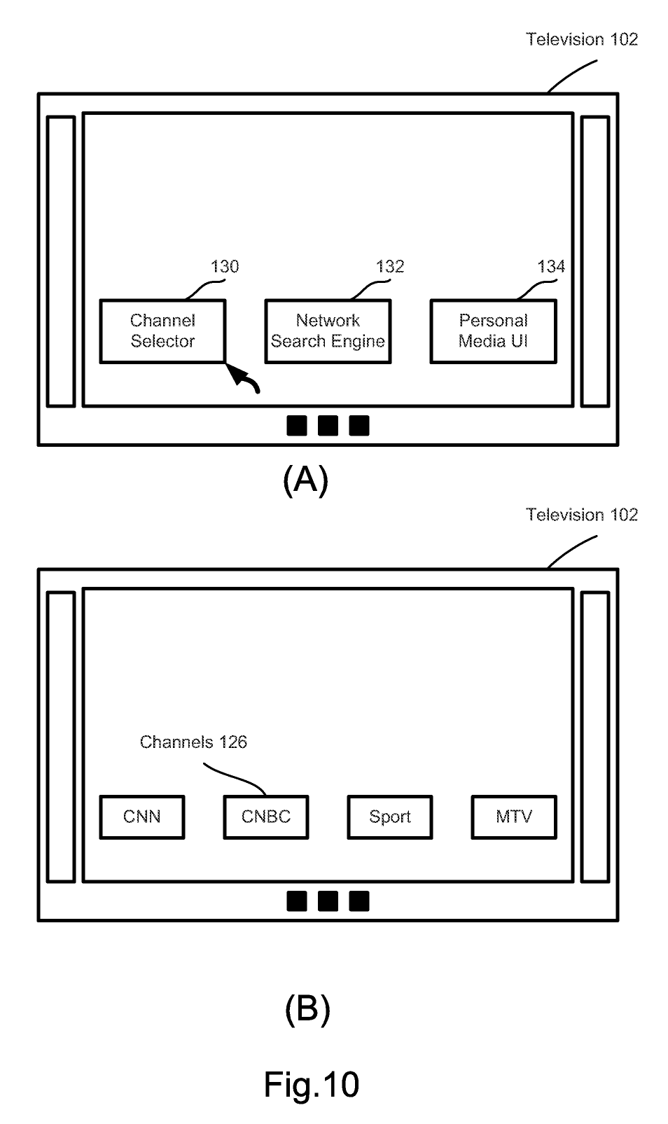

After personal device 108 is connected to basic TV system 125, processor 108B takes control of media delivery system 100. Controller 102B takes instruction from processor 108B. Processor 108B receives instruction from a user through remote control device 106 and displays UI 102D on the display of TV 102. UI 102D is organized in a hierarchical structure and is rendered to the user progressively in a level by level manner A first display screen of an exemplary UI 102D is illustrated in FIG. 10A. User selectable items at the first hierarchical level include at least channel selector 130 and network search engine 132. Channel selector 130 is pertaining to selecting a channel program from a plurality of channels provided by channel content provider 104. Network search engine 132 which is enabled by personal mobile device 108 provides network search functions to system 100. Media items including video program can be distributed by network content provider 112 to system 100 through communication link 105.

The first hierarchical level of UI 102D may also include a personal media UI 134 for accessing media items stored in storage unit 108D of personal mobile device 108. Inclusion of personal media UI 134 in the first display screen of UI 102D is optional and should not limit the scope of the present inventive concept.

It should be noted that rendering UI 102D is controlled by processor 108B. Basic TV system 125 does not provide the user interface that includes a network search engine. Network search engine 132 becomes a function available in an ad hoc manner depending on if personal mobile device 108 is connected to TV 102.

If the user selects channel selector 130 through remote control 106, an exemplary second level of the hierarchical user interface is illustrated in FIG. 10B. A plurality of user selectable channels 126 is displayed in a refreshed screen. In another aspect, the user's identity is readily known to the system after personal mobile device is connected to TV 102. A history relate to user's selections of the channels can be recorded. The channels with highest hit rate by the user may be displayed with priority or be displayed in more visible means.

In another aspect related to channel selector 130, the user may review a schedule of TV programs for one or more channels. The user may select from a menu a scheduled program for recording. In response to user selection, processor 108B schedules a recording action and executes the action accordingly in a later time. The recorded program may be stored in storage unit 108D. The recorded program may be rendered through TV 102 when personal mobile device is connected to TV 102. The recorded program may also be rendered through personal device 108 if the device is not connected to TV 102. The recorded program may be organized as one of media categories together with other personal media categories.

In yet another aspect, a program being broadcasted may also be recorded at a breaking or pausing point and be stored into personal mobile device 108. The program can be resumed either through TV 102 or through personal mobile device 108 in a later time.

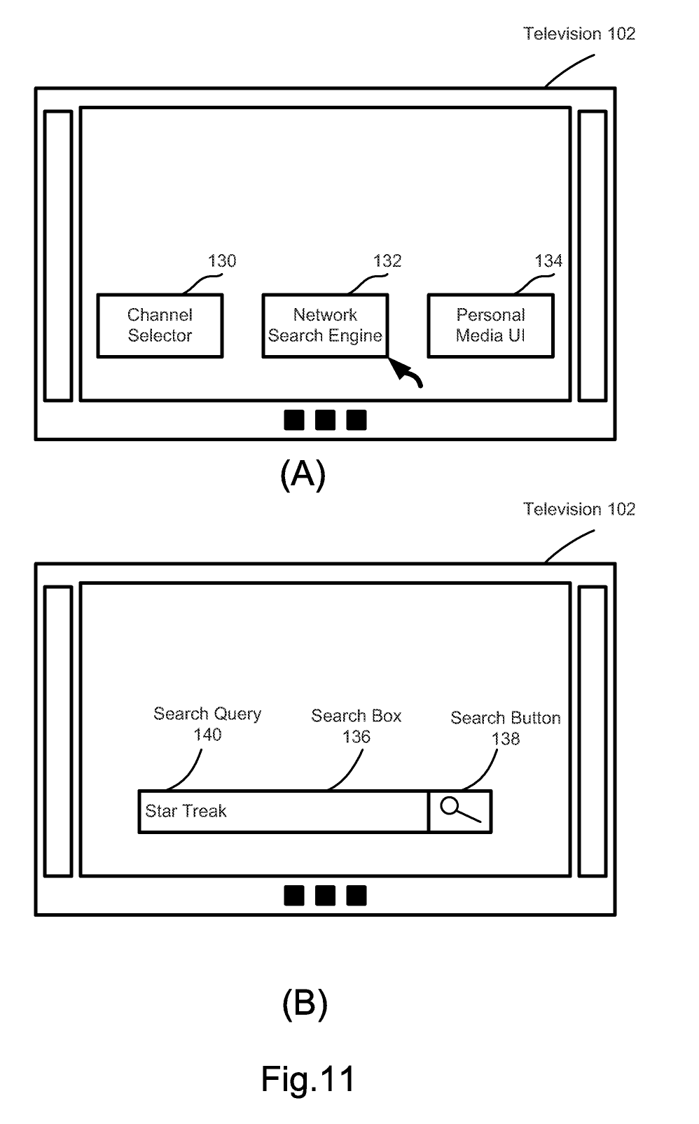

As shown in FIG. 11A-B, if the user selects network search engine 132, a search box 136 and a search button 138 are displayed subsequently in a refreshed screen. In one implementation, search query 140 can be keyed in by the user employing remote control 106. In another implementation, search query 140 can also be received by a voice recognition module. The voice recognition module can be disposed in remote control 106 or in personal mobile device 108. Inclusion of a voice recognition module in a personal mobile device has become popular recently. Many of the devices such as the smart phone, the tablet computer and the smart watch have been equipped with the voice recognition modules. Therefore, implementing a voice related search function is straightforward in system 110.

In another aspect related to network search engine 132, the user's identity is readily known to the system after personal mobile device 108 is connected to TV 102. A personal profile about the user may be included in the device. A record about the user's search history and the user's media selection history can also be stored. The personal profile can be used to improve accuracies of the search engine.

In response to search query 140, network content provider 112 deliveries one or more potential results to personal device 108. The potential results are displayed on TV 102 by the processor 108B. The user may select one of the results through remote control 106. In response to user selection, a media item is delivered from cloud 110 to TV 102. The user may also refine the search query and receive improved results.

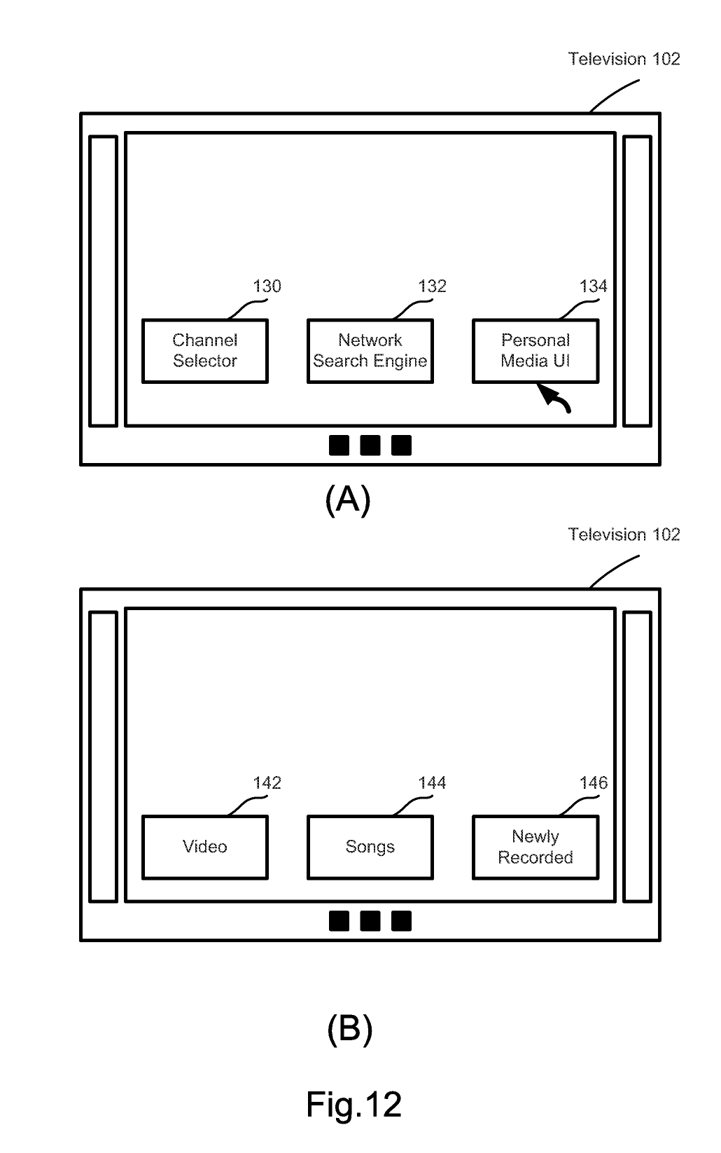

Personal media UI 134 can be optionally displayed on TV 102. If displayed UI 134 is selected by the user as shown in FIG. 12A. User selectable media categories are displayed in a refreshed screen as shown in FIG. 12B. The media categories include in an exemplary manner video 142, songs 144 and newly recorded media item 146. A media item can be selected by the user navigating through the user interface. Newly recorded category 146 includes recorded TV programs in an earlier time.

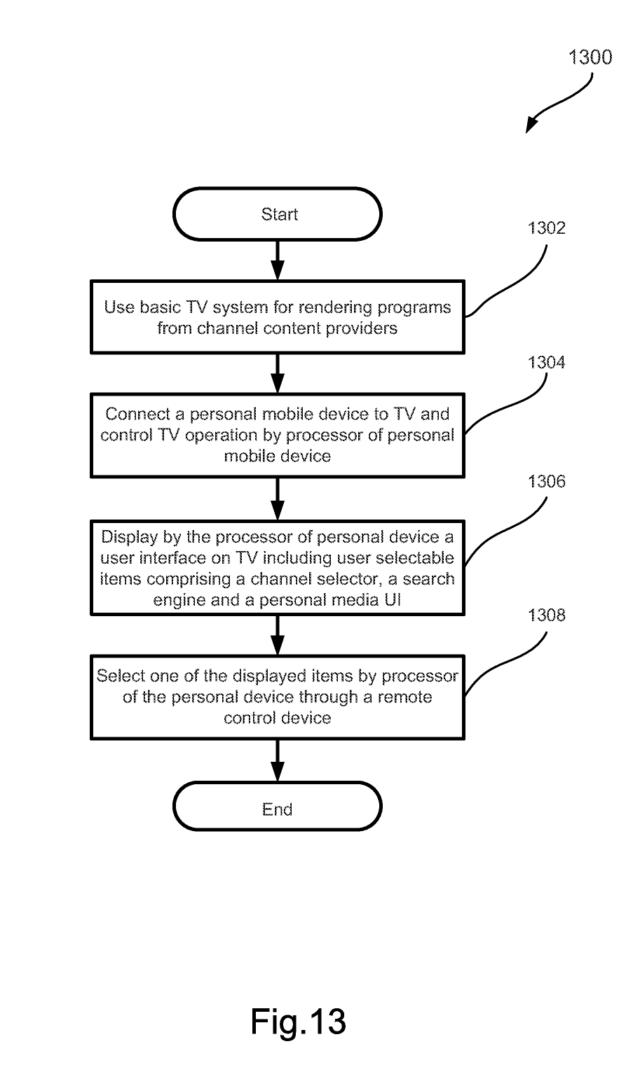

FIG. 13 is a flowchart illustrating exemplarily operation of the media delivery system 100. Process 1300 starts with step 1302 that basic TV system 125 is used for delivering TV programs provided by channel content providers 104. Personal mobile device 108 is connected to TV 102 in step 1304 through communication link 101. Subsequently, processor 108B takes control over TV 102. In step 1306, processor 108B displays the first screen of UI 102D on TV 102. The first hierarchical level of displayed UI 102D includes at least channel selector 130 and network search engine 132. The first screen can also include optionally a personal media UI 134. The user selects in step 1308 one of the displayed items from the first screen through remote control 106. In response to user selection, a control signal generated by remote control 106 is transmitted to personal mobile device 108 through communication link 103.

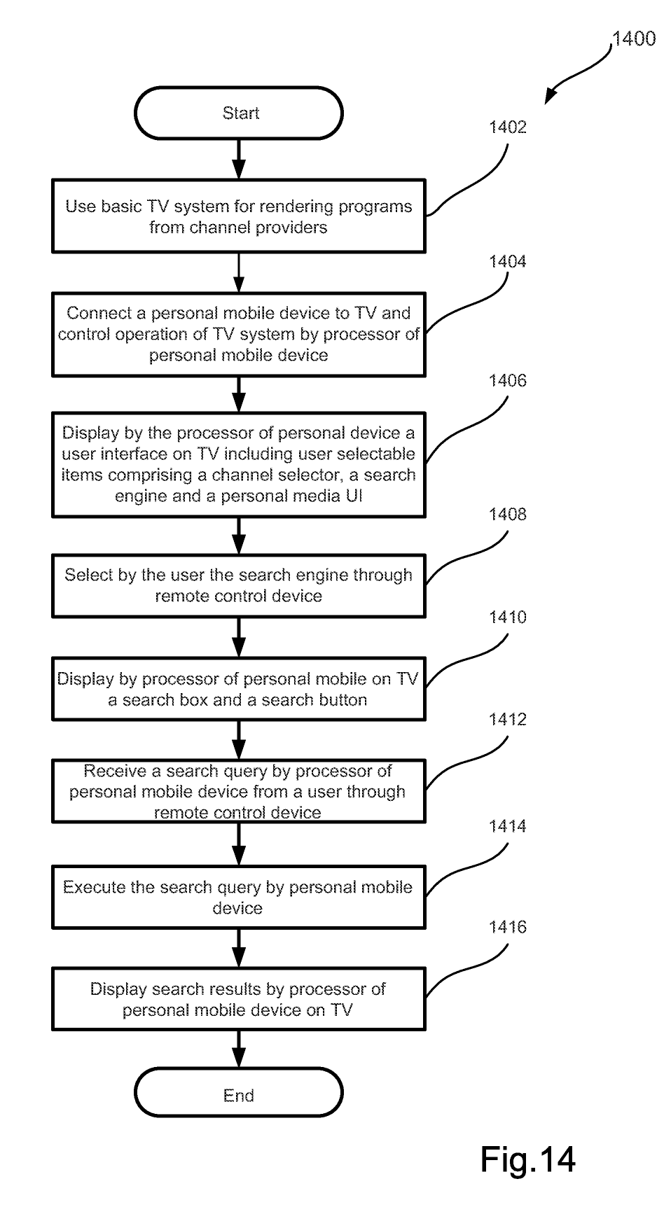

FIG. 14 is a flowchart illustrating exemplarily search operation of the media delivery system 100. Process 1400 starts with step 1402 that basic TV system 125 is used for delivering TV programs provided by channel content providers 104. Personal mobile device 108 is connected to TV 102 in step 1404 through communication link 101. Subsequently, processor 108B takes control over TV 102. In step 1406, processor 108B displays the first screen of UI 102D on TV 102. The first hierarchical level of displayed UI 102D includes at least channel selector 130 and network search engine 132. The first screen can also include optionally a personal media UI 134. The user selects in step 1408 network search engine 132 through remote control 106. In response to user selection, search box 136 and search button 138 are displayed on a refreshed screen in step 1410. Search query 140 is received by processor 108B in step 1412 and is displayed. Search query 140 may be keyed in by the user through remote control 106. Search query 140 may also be received through a voice recognition unit disposed in personal mobile device 108 or in remote control device 106. Network search operation based on search query 140 is executed in step 1414 by processor 108B. Search results are displayed on TV 102 by processor 108B in step 1416.

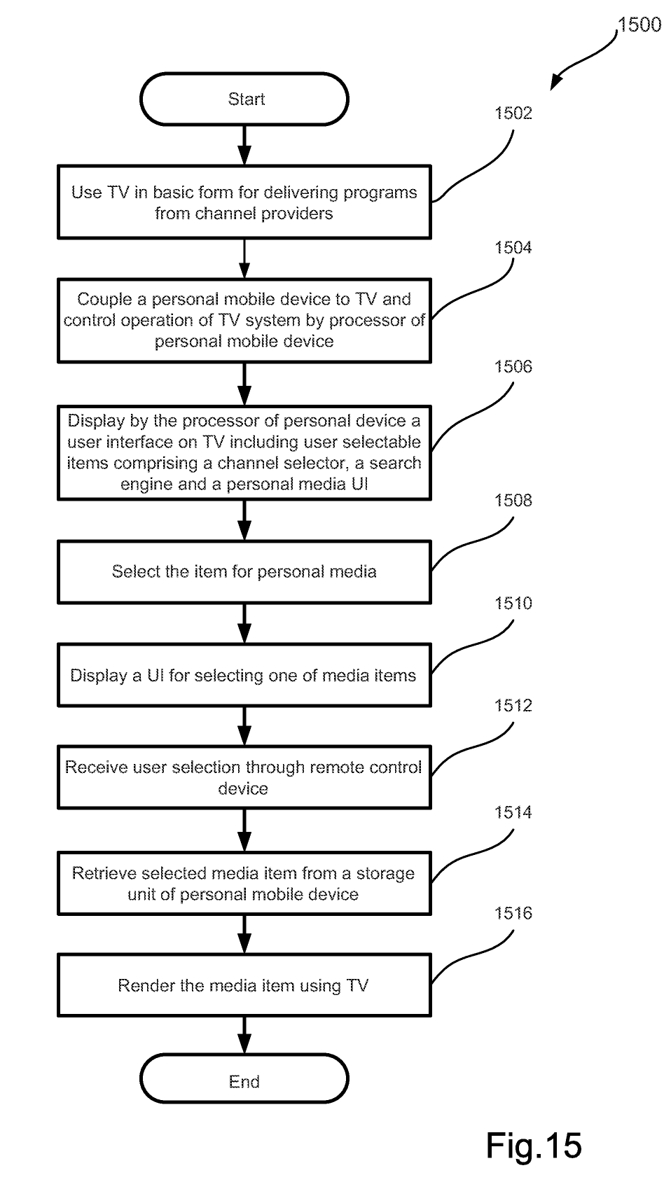

FIG. 15 is a flowchart illustrating exemplarily operation for accessing personal media based upon the media delivery system 100. Process 1500 starts with step 1502 that basic TV system 125 is used for delivering TV programs provided by channel content providers 104. Personal mobile device 108 is connected to TV 102 in step 1504 through communication link 101. Subsequently, processor 108B takes control over TV 102. In step 1506, processor 108B displays the first screen of UI 102D on TV 102. The first hierarchical level of displayed UI 102D includes at least channel selector 130 and network search engine 132. The first screen can also include optionally a personal media UI 134. The user selects in step 1508 personal media UI 134 through remote control 106. In response to user selection, a plurality of personal media categories is displayed by processor 108B. One of the media categories is selected by the user in step 1512 through remote control device 106. A media item can be selected in step 1514 by the user navigating progressively through personal media UI 134. In step 1516, selected media item is rendered using TV 102 by processor 108B.

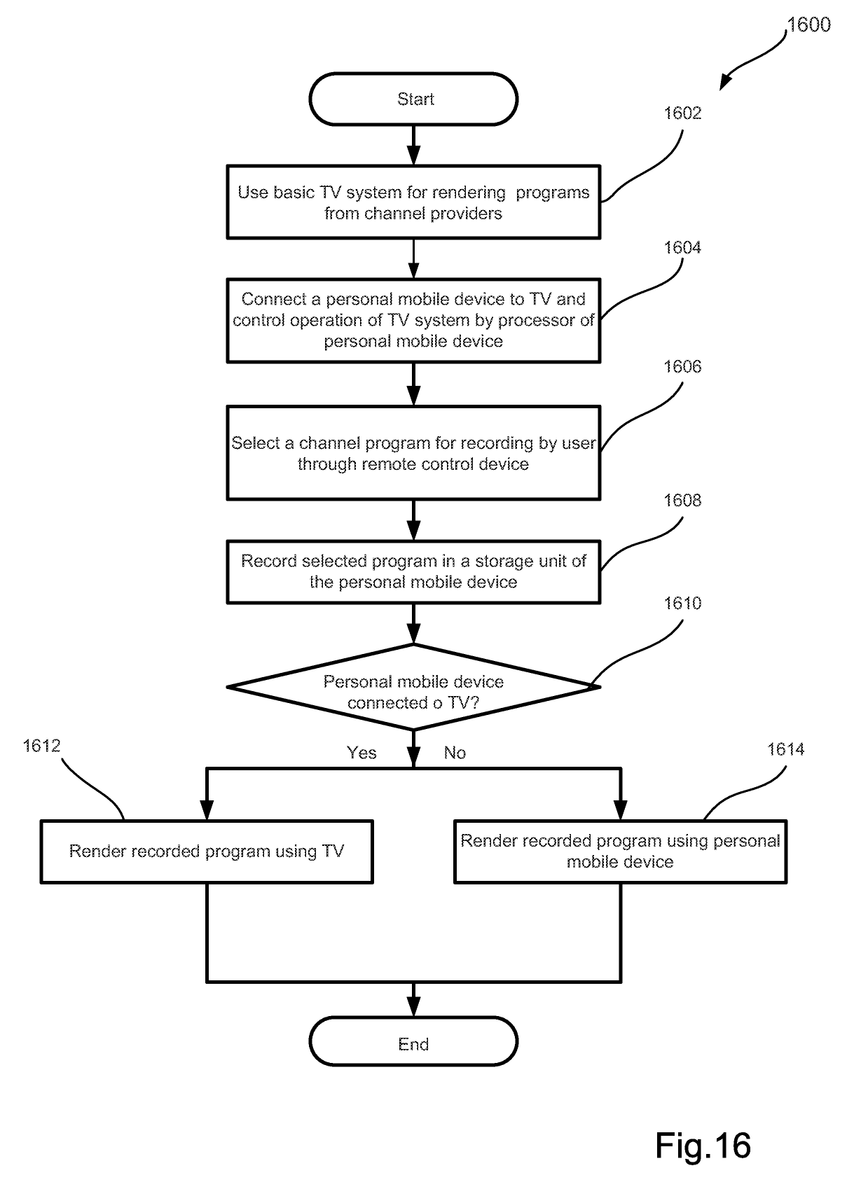

FIG. 16 is a flowchart illustrating exemplarily operation for recoding and rendering recorded program based upon the media delivery system 100. Process 1600 starts with step 1602 that basic TV system 125 is used for receiving and rendering TV programs provided by channel content providers 104. Personal mobile device 108 is connected to TV 102 in step 1604 through communication link 101. Subsequently, processor 108B takes control over TV 102. In step 1606, a channel program is selected by the user through remote control 106 for recording. Processor 108B executes recording of selected program and stores recorded program in storage unit 102D in step 1608. Processor 108B decides if personal device 108 is connected to TV 102 in step 1610. If result is positive, recorded program is rendered using TV 102 in step 1612. Otherwise, recorded program is rendered using personal mobile device in standalone form in step 1614.

1. A media delivery system comprising:
a. a basic television system including a television pertaining to rendering programs from channel program content providers;
b. a personal mobile device connectable to the television through a communication link as an ad hoc set-top box pertaining to receiving media items from a communication network and to rendering received media items through the television, wherein said personal mobile device is a general purpose computing and communication device when said device is disconnected from the television;
c. a user interface rendered to a user on the television by a processor of said personal mobile device, said user interface providing user selectable items including at least a network search engine and a channel selector; and
d. a remote control device connectable to said personal mobile device.

2. The system as recited in claim 1, wherein said communication link further comprising an ad hoc wireless communication link.

3. The system as recited in claim 1, wherein communication link further comprising a docking system.

4. The system as recited in claim 1, wherein said user interface rendered by said personal mobile device further comprising a personal media user interface pertaining to accessing media items stored in a storage unit of said personal mobile device.

5. The system as recited in claim 1, wherein said user interface rendered by said personal mobile device further comprising a user selectable item for recording a channel program and for storing recorded program in a storage unit of the personal mobile device.

6. The system as recited in claim 5, wherein said channel program can be rendered through the television if said personal device is connected to the television or said channel program can be rendered by said personal mobile device if said personal mobile device is not connected to the television.

7. The system as recited in claim 1, wherein said personal mobile device comprising a smart phone.

8. The system as recited in claim 1, wherein said personal mobile device comprising a tablet computer.

9. The system as recited in claim 1, wherein said personal mobile device comprising a smart watch and said remote control device comprising a smart phone, wherein said smart phone providing a network interface.

10. The system as recite din claim 1, wherein said personal mobile device comprising a smart phone and said remote control device comprising a smart watch.

11. The system as recited in claim 10, wherein said smart watch displays a blanket screen for receiving signals generated from a finger's touching the screen, wherein said smart phone synchronizes movements of the finger and movements of an optical symbol on the television.

12. The system as recited in claim 1, wherein said remote control device is a general purpose mobile computing and communication device.

13. A method of delivering a media item through a media delivery system comprising a television and a personal mobile device connectable to the television, comprising:
a. operating the television for rendering channel programs from channel content providers;
b. connecting the personal mobile device to the television through a communication link;
c. displaying a user interface on the television by a processor of the personal mobile device, said user interface further comprising user selectable items comprising at least a channel selector and a network search engine; and
d. selecting by the processor a media item through the user interface by a remote control device; and
e. rendering by the processor selected media item employing the television.

14. The method as recited in claim 13, wherein said user interface further comprising a personal media user interface pertaining to accessing media items stored in a storage unit of the personal mobile device.

15. The method as recited in claim 13, wherein said method further comprising selecting a channel program by the personal mobile device and recording the channel program to a storage unit of the personal mobile device.

16. The method as recited in claim 15, wherein said method further comprising rendering recorded channel program employing the television by the personal mobile device if the personal mobile device is connected to the television.

17. The method as recited in claim 15, wherein said method further comprising rendering recorded channel program employing the personal mobile device if the personal mobile device is not connected to the television.

18. A video program delivery system comprising:
a. a television pertaining to rendering video programs from channel program content providers;
b. a smart watch connectable through a communication link to said television pertaining to controlling operations of said television;
c. a smart phone connectable to said smart watch through a communication link as a remote control device, wherein said smart phone through said smart watch providing a network interface for said television; and
d. a user interface rendered to a user on said television by said smart watch, said user interface providing user selectable items including a channel selector, a network search engine and a personal media user interface pertaining to accessing at least video programs stored in a storage unit of said smart watch.

19. The system as recited in claim 18, wherein said smart watch and said phone are connectable through an ad hoc wireless communication link.

20. The system as recited in claim 18, wherein said smart watch is connected to said television through an ad hoc wireless communication link or through a docking system.
